(19) United States
(12) Patent Application Publication
(10) Pub. No.: US 2014/0219164 A1
(43) Pub. Date: Aug. 7, 2014

(54) Hardware-Based Private Network Using WiMAX

(71) Applicants: David Sanders, Moclips, WA (US); Naomi Elizabeth, San Diego, CA (US)

(72) Inventors: David Sanders, Moclips, WA (US); Naomi Elizabeth, San Diego, CA (US)

(21) Appl. No.: 13/761,152

(22) Filed: Feb. 7, 2013

(51) Int. Cl. H04W 12/02; H04W 84/18

(52) U.S. Cl. CPC H04W 12/02; H04W 84/18
USPC 370/328

(57) ABSTRACT

A private data and voice network which uses the Worldwide Interoperability for Microwave Access (WiMAX) system to connect groups of users via mobile handset devices. A WiMAX transmitter facilitates communication between wireless devices on the network, which are connected remotely by a server which routes encrypted shared data. The network operates independently, without the use of any cable Internet systems or wireless Internet.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

The invention pertains to data and voice networks, and the secure relay of data between users along a network. It creates a new option for local digital communication which bypasses the need for Internet service providers and telephone service providers.

### BACKGROUND OF THE INVENTION

It is well known that communications companies generally rely on an international series of heavy optical fiber cables to build the physical structure of large data networks worldwide. Subsequently these companies make the data networks available for consumer use. The cables comprise a bulky, inflexible system which is complicated and expensive to maintain. For this reason, they are owned and controlled by a small number of powerful entities. Yet for short range local networks, the WiMAX technology can potentially enable groups of users to connect with each other without the use of these existing cable systems. It can be possible to forego the use of traditional Internet architectures and build an alternate series of networks that is lighter and more decentralized, enabling much more control for the users themselves.

Additionally, the current framework of the Internet creates many vulnerabilities wherein sensitive data is often accessed by unauthorized parties. World governments are frequently compromised by foreign nationals and individuals seeking to obtain classified information for various reasons. Private citizens using the Internet to conduct business and make monetary transactions are very often the victims of similar data theft and misuse. It is important for society's future that the general state of technology moves towards more secure methods of operation. This proposed system offers a way to create networks that are inherently more secure, by utilizing novel types of encryption keys and excluding unauthorized users from accessing the data.

### SUMMARY OF THE INVENTION

It is therefore an object of the invention to develop a networking system which has no reliance on existing cable or wireless networks. The network operates independently, without any connection to the Internet, although the option for the user to connect to the Internet is offered, via a secure VPN (Virtual Private Network) tunnel.

The network consists of a WiMAX transmitter and a server, which facilitates the connection between remote wireless handheld devices and routes shared content. The server does not store any of the content, it only routes the information to the correct device or devices. The device encrypts communications between server and device, and server and other devices in order to exchange all types of data. The types of data include but are not limited to voice, photo, text, video, and sound. Additionally, each device itself may have the capability to act as a server, and to store real time data.

In this proposed system, the server and the WiMAX transmitter can be physically combined and manufactured as a single portable hardware unit, and all of the units may be owned and maintained by the users themselves. This is in direct contrast to the existing state of network connectivity, wherein generally users are the customers of Internet service providers and telephone service providers, and don't own any of the requisite equipment to run the network. Currently, ISPs and phone companies generally collect data and track the communications of their customers. However in this system, there is no central owner of the network and there is no long term storage of the traffic along the network.

The proposed network is flexible in its size requirements and can serve a small group or a large geographic area as needed. It will be location-based and expandable. Multiple networks can be set up and kept separate from each other in the same geographic area. It is a secure means of communication for the users included in the group, and summarily rejects unauthorized users. Only devices which have access to a particular network will be able to access the communications along that network. The method of encryption of the system ensures that transmissions remain private. Each device contains embedded software that allows for secure communication.

### BRIEF DESCRIPTION OF THE DRAWINGS

FIG. 1 This drawing represents two networks operating in the same geographic area, that are kept separate from each other, and maintain privacy by using independent passphrases.

FIG. 2 This drawing illustrates how a local network could connect to a remote network by using a VPN tunnel.

FIG. 3 This drawing shows how a third party smart phone could be enabled to communicate with the network via a downloaded app.

FIG. 4 This is a depiction of two networks operating in the same geographic area, which have chosen to merge, allowing the users of both networks to communicate with each other.

FIG. 5 In this drawing, a network's range is greatly expanded by the addition of supplementary WiMAX transmitters.

### DETAILED DESCRIPTION OF THE PREFERRED INVENTION

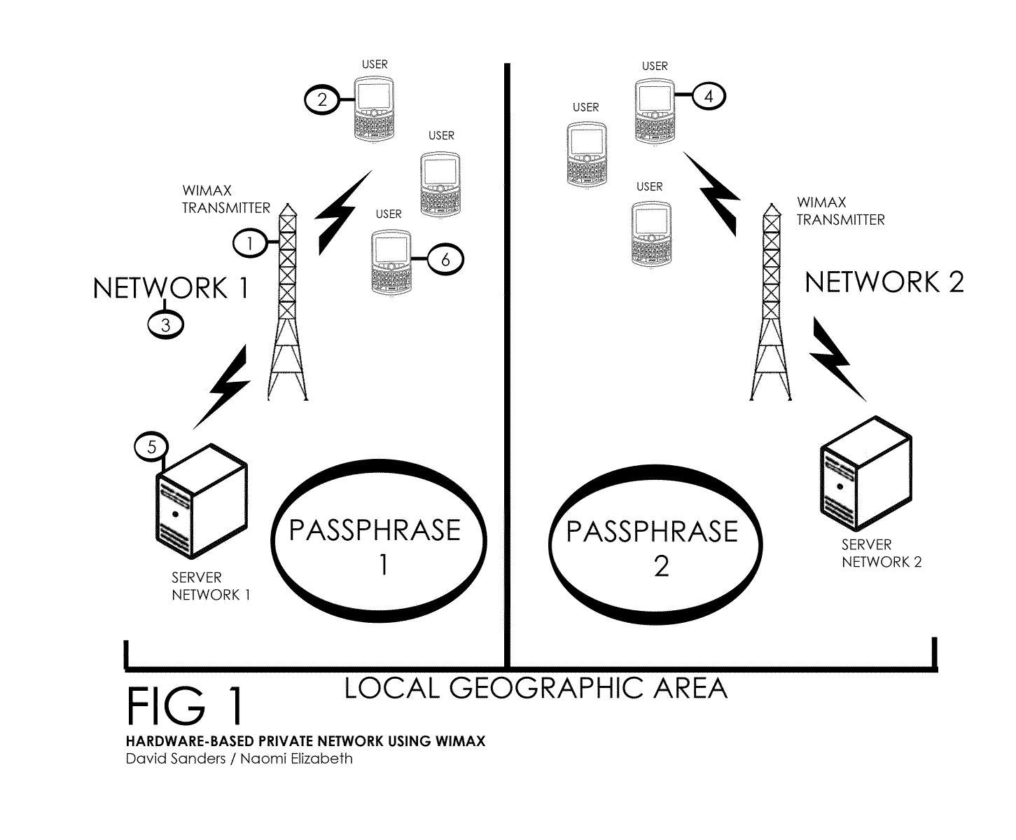

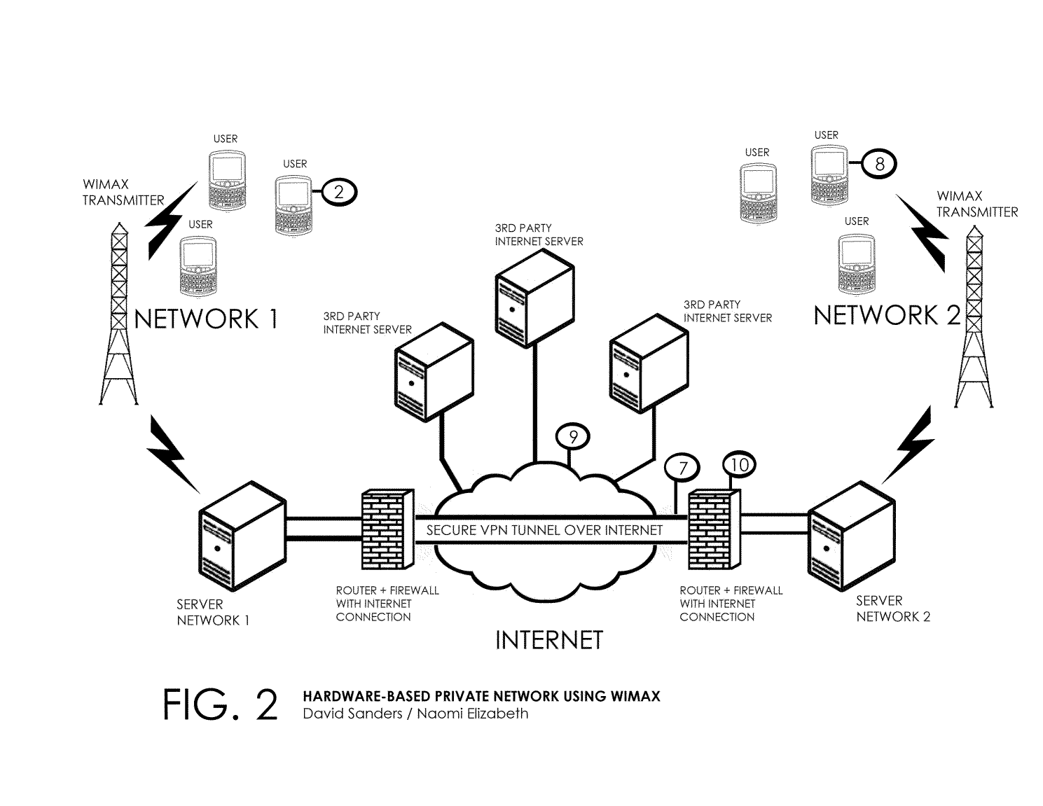

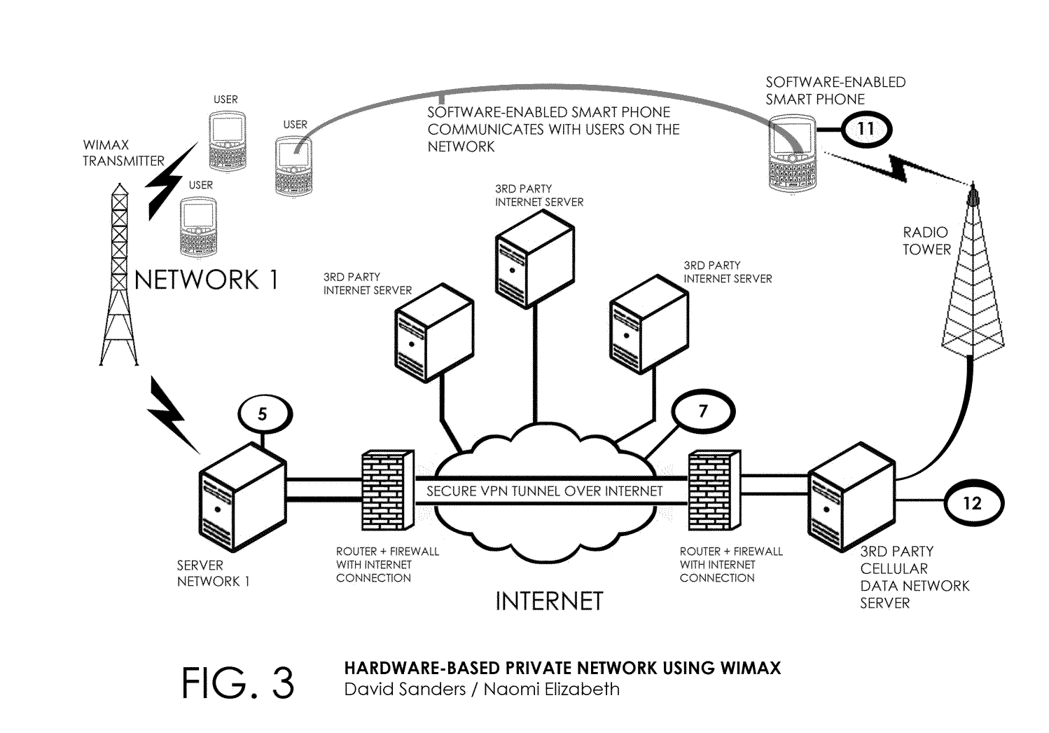

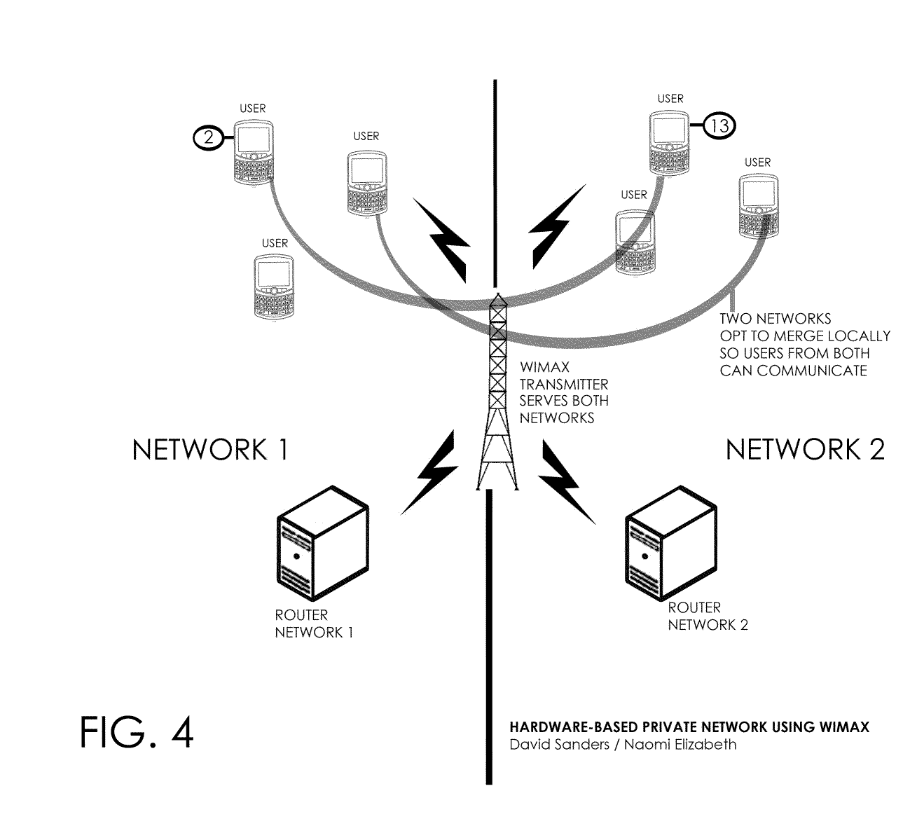

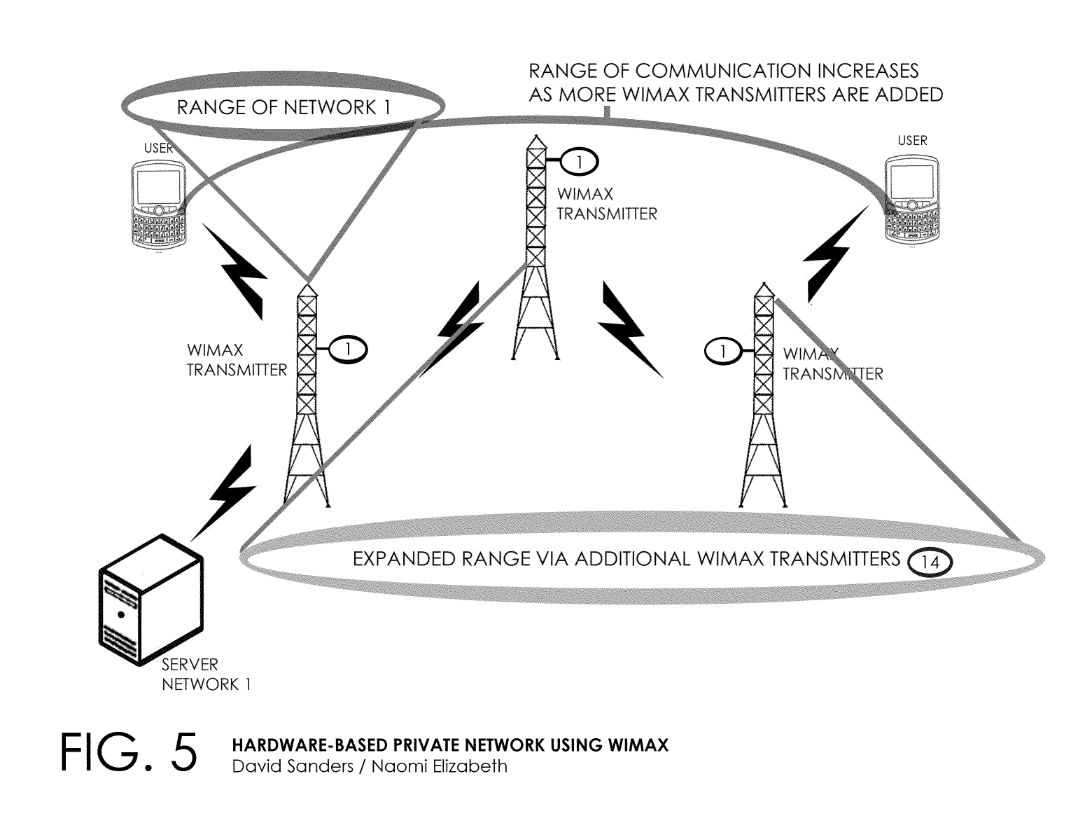

1. The WiMAX transmitter (1) is an access point which transmits beacons of data, similar to a WIFI access point. The wireless mobile device (2) sends a request to the WiMAX transmitter for permission to join the network.
2. The WiMAX transmitter, serving as the authenticator, will either accept or reject the wireless device/client. It creates an authentication request. This packet includes information identifying the specific transmitter that is requesting the login credentials. The user credentials are encrypted to avoid a passive “listener” (4) from sniffing the credentials.
3. The credentials are then validated: the server (5) decrypts the packet and checks the credentials for approved users.
4. If the credentials are valid, the server then sends the device an authentication acknowledgement. If the credentials are not valid, the server sends an authentication reject.
5. If accepted, the device then is registered on the network through DHCP.
6. The software on each device requests a list of devices/users currently connected to the network, and stores them on the device for communication.
7. A device (2) wishes to communicate with another device (6) and initiates a connection. The second device (6) is running a scaled down VPN (Virtual Private Network) service with IPSec (Internet Protocol Security).
8. Device (2) and device (6) negotiate a encrypted connection, spelling out the details of the encryption mechanism. During the course of communication between the devices, the encryption key is randomly generated and changed at predesired intervals.
9.The initiating device (2) sends its preferred key list to device (6), which has been generated by software mechanisms on device (2). The rate of alternating keys is exchanged at the negotiation of the initial connection. A security function can optionally be set by the user of each device determining how often the key is changed.
10.After the devices are connected to the network, the server (5) brokers connections between individual devices only by routing encrypted packets from one device to the next. The only time the server decrypts information is during the initial authentication.
11. The server acts as a VPN server between the devices, encrypting all traffic. Each device temporarily stores the predetermined keys and all decryption of information exchanged between devices is handled by the receiving device.
12. As shown in FIG. 1, it is possible to set up the network so that it is an enclosed system which will not allow new members (3). Any device which is unauthorized (4) will be rejected from accessing the network. Therefore multiple networks can exist in the same geographic area without compromising their security.
12. FIG. 2 illustrates how to make a connection between two devices that are located in geographically remote areas, outside the range that the WiMAX technology is capable of supporting. In this instance, it is possible to establish a VPN (Virtual Private Network) tunnel (7).
13. The VPN client on one device (2) connects to a VPN server on the second device (8).
14. The VPN server assigns an IP address to the VPN client from the VPN server's subnet.
15. The client gets internal IP address 192.168.1.50, for example, and creates a virtual network interface through which it will send encrypted packets to the other tunnel endpoint (the device at the other end of the tunnel). (This interface also gets the address 192.168.1.50.)
16. It prepares a packet addressed to 192.168.1.10, encrypts it and encapsulates it in an outer VPN packet, say an IPSec packet. This packet is then sent to the VPN server at IP address 5.6.7.8 over the public Internet (9). The inner packet is encrypted so that even if someone intercepts the packet over the Internet, they cannot get any information from it. The outside observer can see that the remote host is communicating with a server/firewall (10), but none of the contents of the communication will be viewable.
17. The inner encrypted packet has the source address 192.168.1.50 and destination address 192.168.1.10. The outer packet has the source address 1.2.3.4 and destination address 5.6.7.8.
18. When the packet reaches the VPN server from the Internet, the VPN server decapsulates the inner packet, decrypts it, finds the destination address to be 192.168.1.10, and forwards it to the intended server at 192.168.1.10.
19. After some time, the VPN server receives a reply packet from 192.168.1.10, intended for 192.168.1.50. The VPN server consults its routing table, and sees this packet is intended for a remote host that must go through VPN.
20. The VPN server encrypts this reply packet, encapsulates it in a VPN packet and sends it out over the Internet. The inner encrypted packet has source address 192.168.1.10 and destination address 192.168.1.50. The outer VPN packet has source address 5.6.7.8 and destination address 1.2.3.4.
21. The remote host receives the packet. The VPN client decapsulates the inner packet, decrypts it, and passes it to the appropriate software in the upper layers of the device.
22. In the interest of creating a portable and decentralized network, the three main components of the system (the wireless device, the server, and the WiMAX transmitter) do not need to be manufactured as three separate entities. The WiMAX transmitter (1) and the server (5) can be manufactured either as two separate hardware units, or combined into one hardware unit which functions both as a transmitter/receiver and as a server.
23.FIG. 3 shows that it is possible to build an application for current smartphones (11) to use to connect to the proposed network. The smartphone application would function by transitioning the phone away from the phone's carrier's data connection (12) and onto the private network. It would initiate a VPN tunnel (7) through its carrier's data connection, which would connect to a server (5) on the private network. The smartphone would be assigned a username and be added to the list of current users on the network.
24. In FIG. 4, it is shown that multiple networks existing in the same geographic area may choose to combine user bases and publically expand the scope of the networks. The user of device (2) on Network 1 can communicate with the user of device (13) on Network 2. A single WiMAX transmitter can carry traffic to any network operating within its range.
25. The nature of the WiMAX technology limits a single transmitter to a finite geographical range, which on one level limits the potential size of any individual network. However, as shown in FIG. 5, it does not entirely hinder the possibility of growth of said network, because as additional users may be added, the addition of extra WiMAX transmitters (1) on the network amplifies and extends the range (14) of the network.

1. A private data network comprising:
a series of mobile handset devices
a series of WiMAX enabled beacon transmitters
a series of portable servers

2. The network according to claim 1 wherein all devices are connected via WiMAX without the support of any land based Internet connectivity.

3. The network according to claim 1 wherein all devices are connected via WiMAX without the support of any WIFI connectivity.

4. The network according to claim 2 wherein two geographically remote networks are connected to each other via a VPN tunnel through the Internet.

5. The network according to claim 2 wherein all devices utilize a system of rotating encryption keys to ensure the privacy of the data being transmitted.

6. The network according to claim 1 wherein the WiMAX transmitter and the portable server are manufactured as a single hardware unit.

7. The network according to claim 1 wherein a smart phone uses an application designed to impart connectivity to the network via a VPN tunnel.

8. The network according to claim 2 wherein a network is set up to reject unauthorized users, maintaining privacy and remaining at a static membership.

9. The network according to claim 2 wherein a network is set up to remain open to new users, enabling the capability to expand in size and geographic scope.
